(19) United States
(12) Patent Application Publication
(10) Pub. No.: US 2006/0269381 A1
(43) Pub. Date: Nov. 30, 2006

(54) Bugle shaped head nail

(75) Inventors: Christopher Bobrowski, Wheeling, IL (US); John Petrakis, St. Charles, IL (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(73) Assignee: Juno Manufacturing Inc.

(21) Appl. No.: 11/141,623

(22) Filed: May 31, 2005

(51) Int. Cl. F16B 15/00

(52) U.S. Cl. 411/439

(57) ABSTRACT

A nail having a shaft and a bugle shaped head connected to the shaft. The bugle shaped head allows the nail to be driven into a target material surface and extracted without damage to the surface or the nail and without compromising the retention value of the nail.

### FIELD OF INVENTION

The present invention relates to a nail, and, in particular, a nail having a bugle shaped head.

### BACKGROUND OF THE INVENTION

The most common fasteners used in construction are nails and screws. Conventional nails are designed for fast, easy insertion with positive retention. Typically, nails are driven into a target material surface, which makes the extraction process difficult. The flat, thin circular shape of the nail head, when driven flush, makes it almost impossible to engage any type of tool

to gain enough surface contact to extract the nail. There are nails that exist that have been intentionally designed with an extension to allow for extraction, such as double headed roofing nail with a grommet seated under the head; however, these specialty nails are more costly than a standard nail and cannot be used in most applications.

Conventional screws come in a variety of head styles and thread styles for manual (screwdriver) or mechanical (screw gun, etc.) insertion into a target material. Each screw typically has a recess in the screw head to mate with a tool for rotationally inserting the screw into the target surface. One particular conventional screw has a bugle shaped head to accommodate the recess to receive the tool and to provide sufficient leverage for the tool to rotationally insert the screw into the target surface. The recess in the screw head typically increases the manufacturing cost of the screw. In addition, to avoid stripping the recess in the screw head, the conventional screw is made from stronger, but more costly, metal alloys than nails. Although not preferred, screws can be inserted in a nail like fashion, but due to the pitch of the thread of the screw, insertion by this means is difficult and may produce a hole in the target material that does not allow the screw to be sufficiently retained in the target material. Moreover, screws that are rotationally inserted in a target material typically cannot easily be extracted with a hammer claw or other lever arm.

Therefore, a need exists for a relatively inexpensive fastener that may be driven into a target material in a nail like fashion, but that is easily removable.

### SUMMARY OF THE INVENTION

The present invention allows for a nail to be driven into a target material surface and extracted without damage to the surface or the nail without compromising the retention value of the nail.

In particular, the present invention is directed to a nail that has a shaft and a bugle shaped head connected to the shaft.

Other features and advantages of the present invention will be or will become apparent to one with skill in the art upon examination of the following figures and detailed description. It is intended that all such additional features and advantages be included within this description, be within the scope of the invention, and be protected by the accompanying claims.

### BRIEF DESCRIPTION OF THE DRAWINGS

The accompanying drawings, which are incorporated in and constitute a part of this specification, illustrate an implementation of the present invention and, together with the description, serve to explain the advantages and principles of the invention. In the drawings:

FIG. 1 depicts a nail having bugle shaped head in accordance with the present invention; and

FIG. 2 depicts the bugle shaped head nail of FIG. 1 driven into the surface of a target material.

### DETAILED DESCRIPTION OF THE INVENTION

Reference will now be made in detail to an implementation consistent with the present invention as illustrated in the accompanying drawings. Wherever possible, the same reference numbers will be used throughout the drawings and the following description to refer to the same or like parts.

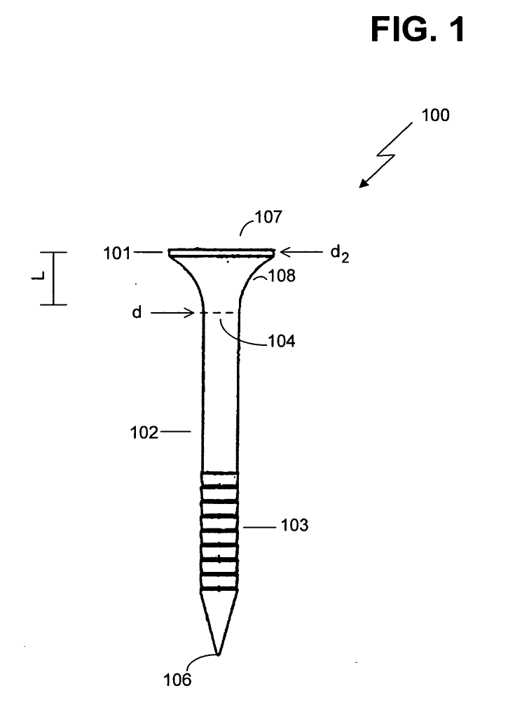

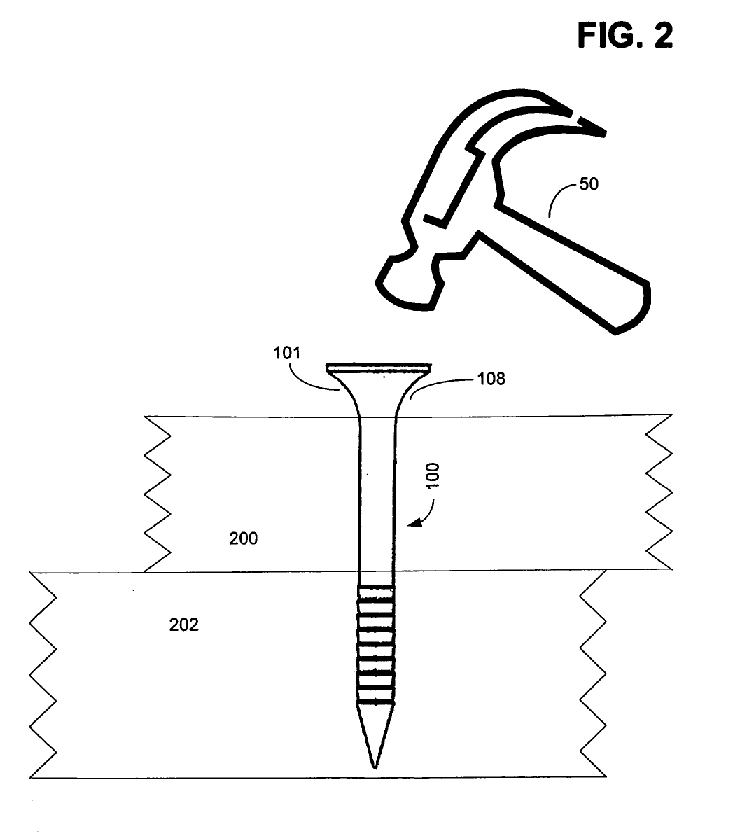

FIG. 1 depicts a nail 100 with a bugle shaped head 101 and a shaft 102. The nail 100 includes a plurality of flared ridges 103. Each of the flared ridges 103 extends towards the bugle shaped head and are adapted to substantially retain the shaft in a target material 200 in FIG. 2. In one implementation, each of the flared ridges 103 separately encircle the shaft 102 without forming threads on the shaft 102. The shaft 102 is connected to bugle shaped head 101 at end 104, and has a tip 106 opposite the end 104, which has a first diameter (d). The bugle shaped head may be molded to or integrally formed with the shaft 102. The diameter of the shaft 102 at the end 104 may be 0.105 inches or more. The bugle shaped head 101 has a face 107 having a second diameter (d₂) of 0.305 inches or more. The bugle shaped head 101 has a curved taper 108 between the end 104 and the face 107. The bugle shaped head has a length (L) between the end 104 and the face 107 that is at least 0.200 inches so that the curved taper 108 of the bugle shaped head substantially inhibits the nail 101 from being driven flush into a target material. In one implementation, the diameter of the bugle shaped head increases exponentially from the end 104 to the face 107.

In the illustrative example shown in FIG. 2, the nail 100 has been driven into the surface of a target material 200 and 202 using a conventional hammer 50. In accordance with the present invention, the bugle shaped head 101 is inhibited from being driven flush with the surface of a target material 200 and 202 by the curved taper 108 of the bugle shaped head 101.

While various embodiments of the present invention have been described, it will be apparent to those of skill in the art that many more embodiments and implementations are possible that are within the scope of this invention. Accordingly, the present invention is not to be restricted except in light of the attached claims and their equivalents.

What is claimed is:

1. A nail, comprising:
a shaft having an end; and
a bugle shaped head connected to the shaft at the end.

2. The nail according to claim 1, wherein the shaft comprises a flared ridge.

3. The nail according to claim 1, wherein the shaft comprises a plurality of flared ridges extending towards the bugle shaped head and adapted to substantially retain the shaft in a target material.

4. The nail according to claim 1,
wherein the end of the shaft has a first diameter, the bugle shaped head has a face, the face having a second diameter; and
the first diameter and second diameter differ by at least 0.200 inches.

5. The nail according to claim 4, wherein the second diameter is at least 0.305 inches.

6. The nail according to claim 4, wherein the first diameter is at least 0.105 inches.

7. The nail according to claim 6, wherein the curved taper is adapted to inhibit the face from being driven flush with a target material surface.

8. The nail according to claim 1, wherein the bugle shaped head has a face and a curved taper between the end of the shaft and the face.

9. The nail according to claim 8, wherein the end of the shaft has a first diameter, the face of the bugle shaped head has a second diameter, and the diameter of the bugle shaped head increases exponentially from the end to the face.

10. The nail according to claim 1, wherein the nail comprises any metal, including soft metals and alloys.
